(19) United States
(12) Patent Application Publication
(10) Pub. No.: US 2011/0109961 A1
(43) Pub. Date: May 12, 2011

(54) PATTERN PROJECTION APPARATUS, SCANNING CONFOCAL MICROSCOPE, AND PATTERN RADIATING METHOD

(75) Inventors: Shinichi HAYASHI, Tokyo (JP); Hirokazu KUBO, Tokyo (JP)

(73) Assignee: OLYMPUS CORPORATION, Tokyo (JP)

(21) Appl. No.: 12/915,201

(22) Filed: Oct. 29, 2010

(30) Foreign Application Priority Data
Nov. 6, 2009 (JP) 2009-255010

(51) Int. Cl. G02B 21/06; G03B 21/14

(52) U.S. Cl. 359/385; 353/28

(57) ABSTRACT

A pattern projection apparatus includes: a spatial light modulator having a plurality of pixel devices each independently modulating light, and arranged at an optically conjugate position with respect to a sample; and a control device for dividing a modulation pattern of the spatial light modulator for irradiating the sample with illuminating light of a target form into a plurality of submodulation patterns and controlling the spatial light modulator sequentially for each of the plurality of submodulation patterns.

### CROSS REFERENCE TO RELATED APPLICATIONS

This application is based upon and claims the benefit of priority from the prior Japanese Patent Application No. 2009-255010, filed Nov. 6, 2009, the entire contents of which are incorporated herein by reference.

### BACKGROUND OF THE INVENTION

1. Field of the Invention

The present invention relates to the technology of a pattern projection apparatus, a scanning confocal microscope, and a pattern radiating method, and more specifically to the technology of controlling a spatial light modulator.

2. Description of the Related Art

Conventionally, there has been a demand for the technology of arbitrarily controlling the spatial distribution and intensity of light (hereinafter referred to as a pattern) and irradiating an object with a desired pattern of light for a microscope such as a pattern stimulation device etc., a laser repair device, an exposing device, etc. To realize the technology, a spatial light modulator (SLM) has been widely used.

The spatial light modulator has a plurality of light modulation devices (hereinafter referred to as pixel devices), and independently controls the states of the pixel devices, thereby successfully generating a desired pattern. Thus, various propositions have been made regarding to irradiating an object with a desired pattern of light by projecting the spatial light modulator onto the object.

For example, Japanese Laid-open Patent Publication No. 2004-109348 discloses a microscope using a white light source such as a mercury lamp etc. and a digital micromirror device (hereinafter referred to as a DMD).

A DMD is a spatial light modulator for modulating light by deflecting the light with a mirror provided for each pixel device. FIG. 1A is a rough outline of the top view exemplifying the configuration of the DMD. FIG. 1B is a rough outline of the section of the DMD along the section X-X′ illustrated in FIG. 1A. As exemplified in FIG. 1A, a DMD 200 has, for example, a plurality of mirrors 201 each having a side of L are arranged at the pitch of p in the direction of the side in the two-dimensional array. Each mirror 201 is independently controlled and rotates about a rotation axis 202 by the Coulomb force generated between the mirror and an electrode not illustrated in FIG. 1A. Thus, the state of each pixel device is controlled as the ON state in which incident light 203 exemplified in FIG. 1B is led in the direction of the object or the OFF state in which the incident light 203 is led in the direction of a deviation from the object. As a result, a desired pattern can be generated.

Japanese Laid-open Patent Publication No. 10-268263 discloses the technology using a liquid crystal spatial light modulator. In the liquid crystal spatial light modulator described in the patent document, a liquid crystal pixel device functions as a dynamic diffraction grating. Then, non-diffractive light is interrupted, and only diffractive light contributes to the generation of a pattern.

Using the technology disclosed by Japanese Laid-open Patent Publication Nos. 2004-109348 and 10-268263, an object can be irradiated with the light of a desired pattern.

It is normally desired that the light radiated onto an object is monochrome light. When a white light source is used as a light source as exemplified by Japanese Laid-open Patent Publication No. 2004-109348, it is necessary to use a wavelength selection device such as an exciter filter etc. Although the wavelength selection device is used, there is a case in which emitted light has no sufficient monochrome property.

Therefore, it is proposed to use a laser light source for emitting laser light having a high monochrome property as a light source.

For example, U.S. Pat. No. 6,555,826 discloses the technology of using a laser light source with a spatial light modulator such as an LCD (liquid crystal display) etc. and a deformable mirror. Japanese Laid-open Patent Publications No. 2009-028742 and 2003-107361, and U.S. Pat. No. 6,898,004 disclose the technology of using a laser light source with the DMD. U.S. Pat. No. 7,339,148, and Japanese Laid-open Patent Publication Nos. 2008-203813 and 2008-275791 disclose the technology of arbitrarily controlling a confocal aperture using the DMD as a confocal stop of a scanning confocal microscope.

For example, with the DMD 200, as exemplified in FIG. 1B, between beams of laser light which is deflected at adjacent pixel devices (mirror 201), an optical path length difference Δ(=2d sin θ) occurs. As a result, there occurs a phase shift between the beams of laser light.

Also with the liquid crystal spatial light modulator disclosed by U.S. Pat. No. 6,555,826, there occurs an optical path length difference between adjacent pixel devices because the diffractive light is used in generating a pattern as with the DMD above.

Thus, there occurs a phase shift between beams of laser light when there is an optical path length difference between the beams of laser light modulated at the adjacent pixel devices of the spatial light modulator functioning as a diffractive optical device.

International Publication Pamphlet No. WO 2003/040798 and Japanese Laid-open Patent Publication No. 2007-329386 disclose the technology of suppressing the degradation of a pattern by the interference of laser light.

The technology disclosed by International Publication Pamphlet No. WO 2003/040798 refers to the radiation of laser light through a randomizing device, and can suppress the degradation of a pattern by interference.

Generally, a randomizing device changes with time the phase of laser light at random. Therefore, it is effective when the laser light is radiated for over a predetermined time period.

The technology disclosed by Japanese Laid-open Patent Publication No. 2007-329386 inclines the entire DMD used as a variable forming mask. Thus, the optical path length difference between the beams of laser light from adjacent mirror devices is an integral multiple of the wavelength, thereby correcting the phase shift. Accordingly, the degradation of a pattern by the interference can be suppressed.

### SUMMARY OF THE INVENTION

An aspect of the present invention provides a pattern projection apparatus including: a spatial light modulator having a plurality of pixel devices each independently modulating light, and arranged at an optically conjugate position with respect to a sample; and a control device for dividing a modulation pattern of the spatial light modulator for irradiating the sample with illuminating light of a target form into a plurality of submodulation patterns of the spatial light modulator and controlling the spatial light modulator sequentially for each of the plurality of submodulation patterns.

Another aspect of the present invention provides a scanning confocal microscope including: a spatial light modulator having a plurality of pixel devices each independently modulating light, arranged at an optically conjugate position with respect to a sample, and functioning as a confocal stop; and a control device for dividing the aperture pattern of the confocal stop into a plurality of subaperture patterns and controlling the spatial light modulator sequentially for each of the plurality of subaperture patterns for each scanning position.

A further aspect of the present invention provides a pattern radiating method for irradiating the sample with illuminating light including: setting a pattern of the illuminating light for irradiating the sample; dividing the pattern into a plurality of subpatterns subject to little interference; and sequentially irradiating the sample with the plurality of subpatterns.

### BRIEF DESCRIPTION OF THE DRAWINGS

The present invention will be more apparent from the following detailed description when the accompanying drawings are referenced.

FIG. 1A is the outline of the section exemplifying the configuration of a DMD;

FIG. 1B is the outline of the section of the DMD along the section X-X′ illustrated in FIG. 1A;

FIG. 2 is an example of a modulation pattern of the DMD according to an embodiment of the present invention;

FIG. 3A is an example of a submodulation pattern generated by dividing the modulation pattern exemplified in FIG. 2 into two parts;

FIG. 3B is an example of a submodulation pattern generated by dividing the modulation pattern exemplified in FIG. 2 into two parts;

FIG. 4A is an example of a submodulation pattern generated by dividing the modulation pattern exemplified in FIG. 2 into three parts;

FIG. 4B is an example of a submodulation pattern generated by dividing the modulation pattern exemplified in FIG. 2 into three parts;

FIG. 4C is an example of a submodulation pattern generated by dividing the modulation pattern exemplified in FIG. 2 into three parts;

FIG. 5A is an example of a submodulation pattern generated by dividing the modulation pattern exemplified in FIG. 2 into four parts;

FIG. 5B is an example of a submodulation pattern generated by dividing the modulation pattern exemplified in FIG. 2 into four parts;

FIG. 5C is an example of a submodulation pattern generated by dividing the modulation pattern exemplified in FIG. 2 into four parts;

FIG. 5D is an example of a submodulation pattern generated by dividing the modulation pattern exemplified in FIG. 2 into four parts;

FIG. 6A is an example of an aperture pattern of the DMD according to an embodiment of the present invention;

FIG. 6B is an example of an aperture pattern of the DMD according to an embodiment of the present invention;

FIG. 6C is an example of an aperture pattern of the DMD according to an embodiment of the present invention;

FIG. 7A is an example of an aperture subpattern generated by dividing an aperture pattern exemplified in FIGS. 6A through 6C into two parts;

FIG. 7B is an example of an aperture subpattern generated by dividing an aperture pattern exemplified in FIGS. 6A through 6C into two parts;

FIG. 7C is an example of an aperture subpattern generated by dividing an aperture pattern exemplified in FIGS. 6A through 6C into two parts;

FIG. 7D is an example of an aperture subpattern generated by dividing an aperture pattern exemplified in FIGS. 6A through 6C into two parts;

FIG. 7E is an example of an aperture subpattern generated by dividing an aperture pattern exemplified in FIGS. 6A through 6C into two parts;

FIG. 7F is an example of an aperture subpattern generated by dividing an aperture pattern exemplified in FIGS. 6A through 6C into two parts;

FIG. 8 is a flowchart of an example of controlling a pattern projection apparatus including the DMD according to an embodiment of the present invention;

FIG. 9 illustrates the state in which the DMD functions as a diffraction grating;

FIG. 10 is the outline of the top view of the DMD for explanation of the numerical aperture of an optical system fetching modulated light;

FIG. 11 illustrates the outline of the configuration of the laser repair device according to the embodiment 1;

FIG. 12 is the outline exemplifying the configuration of the scanning confocal microscope according to the embodiment 2;

FIG. 13A is an example of an aperture subpattern used in the scanning confocal microscope exemplified in FIG. 12;

FIG. 13B is an example of an aperture subpattern used in the scanning confocal microscope exemplified in FIG. 12;

FIG. 13C is an example of an aperture subpattern used in the scanning confocal microscope exemplified in FIG. 12;

FIG. 14 is the outline exemplifying the configuration of the scanning confocal microscope according to the embodiment 3; and

FIG. 15 is the outline exemplifying the configuration of the scanning confocal microscope according to the embodiment 4.

### DESCRIPTION OF THE PREFERRED EMBODIMENTS

Described first is the method of controlling a spatial light modulator for irradiating an object with the light of a desired pattern without depending on the wavelength of the light. In the descriptions below, the pattern of the light radiated onto an object is referred to as a radiation pattern, and the pattern of the spatial light modulator projected onto the object is referred to as a modulation pattern (or a submodulation pattern).

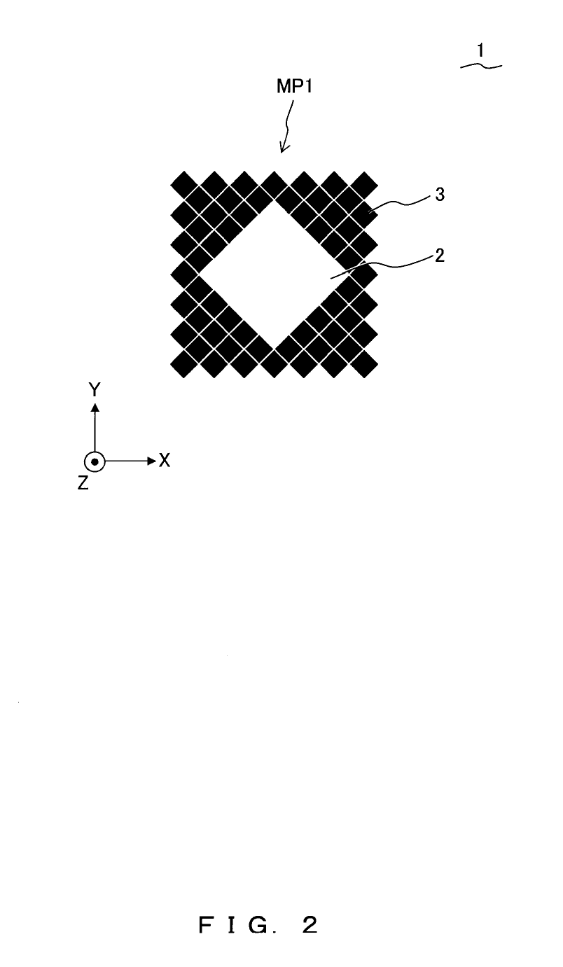

FIG. 2 is an example of a modulation pattern of the DMD according to an embodiment of the present invention. The XYZ coordinate system is provided for convenience in referring to the direction. In this example, the Z axis indicates the vertical direction, and the XY plane indicates the horizontal plane. A DMD 1 is arrangement on the XY plane.

The DMD 1 is included in the pattern projection apparatus for irradiating the sample with the light of a desired pattern, and includes a plurality of pixel devices each independently modulating light. Each pixel device is, for example, controlled so that it can enter the state in which incident light is led to the sample (hereinafter referred to as an ON state (first state)), or enter the state in which the incident light can be led in the direction of deviation from the sample (hereinafter referred to as an OFF state). The pattern projection apparatus is, for example, a pattern stimulation microscope, a laser repair device a medical laser radiation device, a confocal microscope, etc.

Since the DMD 1 is arranged between a light source and a sample in an optically conjugate position with respect to the sample, the sample is projected with the ON/OFF pattern of a pixel device (that is, the modulation pattern of the DMD 1) as is. Therefore, the sample can be irradiated with the light of any radiation pattern by controlling the modulation pattern of the DMD 1.

In FIG. 2, the DMD 1 is controlled so that a modulation pattern MP1 in which a rhombic illuminating light can be radiated onto a sample. In this example, a pixel device 2 indicates a pixel device in the ON state, and a pixel device 3 indicates a pixel device in the OFF state. By thus controlling the DMD 1, only the illuminating light which has entered the pixel device 2 is radiated onto the sample, thereby successfully irradiating the sample with rhombic illuminating light.

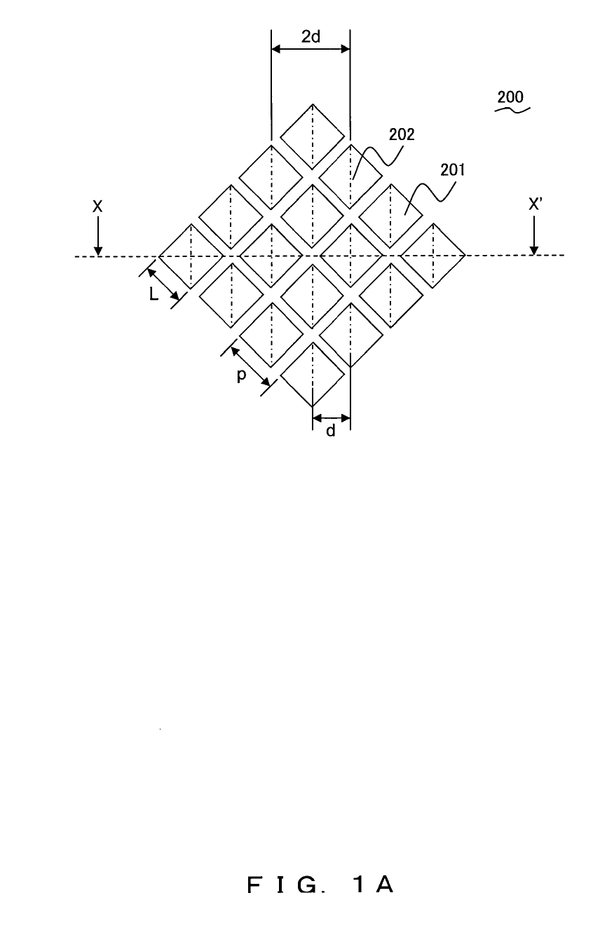

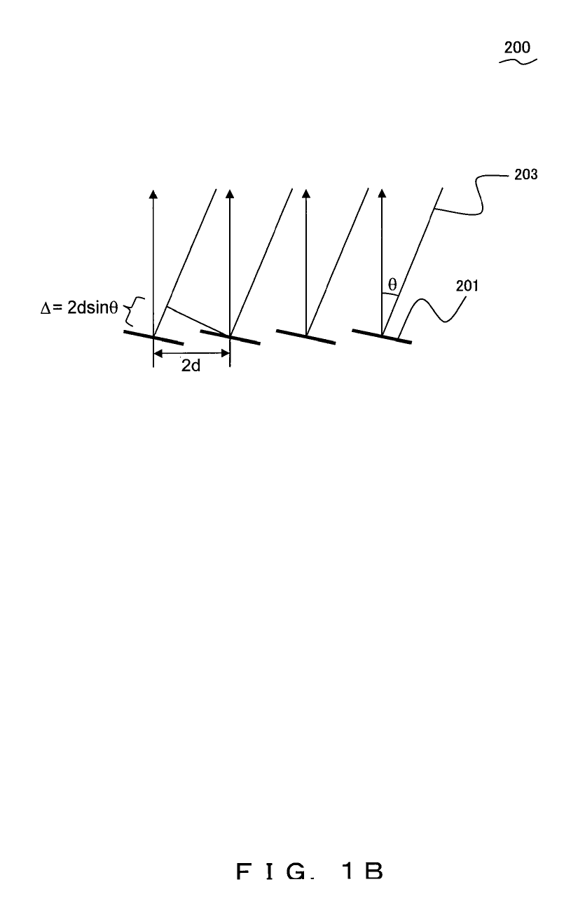

However, as described above with reference to FIGS. 1A and 1B, an optical path length difference can occur between the pixel devices (to be strict, the illuminating light deflected by the pixel devices) in the DMD 1 functioning as a diffraction grating. Therefore, since the laser light is coherent, the radiation pattern is degraded by mutual interference of the illuminating light deflected by the pixel devices which incur an optical path length difference.

Accordingly, the modulation pattern MP1 of the DMD 1 in which the illuminating light of a target shape is radiated onto a sample is divided into a plurality of submodulation patterns. Then, the DMD 1 is controlled for each of the plurality of submodulation patterns by rotation. That is, instead of the modulation pattern MP1, a target radiation pattern can be realized by a combination of submodulation patterns.

Since the illuminating light modulated (deflected) in different submodulation patterns is radiated onto a sample with different timing, the illuminating light does not interferes with each other. Therefore, the control of combining submodulation patterns can suppress the degradation of the radiation pattern by the interference between different beams of illuminating light, as compared with the control of the modulation pattern MP1.

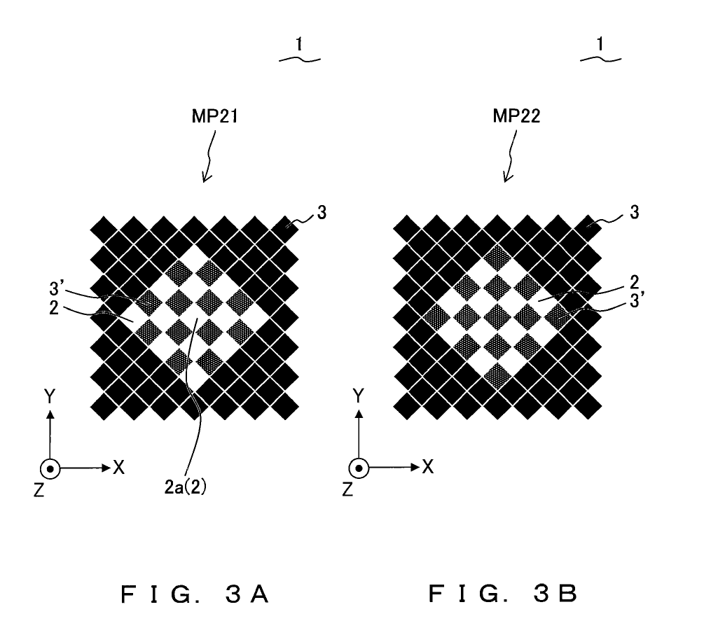

An effective submodulation pattern for suppressing the degradation of the radiation pattern is concretely described below with reference to FIGS. 3A, 3B, 4A through 4C, and 5A through 5D.

In FIGS. 3A, 3B, 4A through 4C, and 5A through 5D, the illuminating light enters parallel to the XZ plane. Therefore, the optical path length difference occurs between the pixel devices having different X coordinates, but does not occur between the pixel devices different only in Y coordinates. That is, in FIGS. 3A, 3B, 4A and 4B, and 5A through 5D, the direction in which an optical path length difference occurs is the X-axis direction, and the direction in which no optical path length difference occurs is the Y-axis direction.

FIGS. 3A and 3B illustrate an example of a submodulation pattern generated by dividing the modulation pattern MP1 exemplified in FIG. 2 into two parts. FIG. 3A exemplifies a submodulation pattern MP21, and FIG. 3B exemplifies a submodulation pattern MP22.

A pixel device 3′ indicates a pixel device in the OFF state as with the pixel device 3. However, the pixel device 3 is controlled so that it is in the OFF state even in the modulation pattern MP1 while the pixel device 3′ is controlled so that it is in the ON state in the modulation pattern MP1.

Described below first is the submodulation pattern MP21 exemplified in FIG. 3A. Each pixel device is enclosed by a total of eight pixel devices, that is, four pixel devices adjacent on the respective points in the diagonal direction (X-axis direction or Y-axis direction) and four pixel devices adjacent on the respective sides.

In the present specification, “pixel devices adjacent on the respective points” refer to the adjacent pixel devices facing each other on the respective vertexes. “Pixel devices adjacent on the respective sides” refer to the adjacent pixel devices facing each other on the respective sides. Between the pixel devices adjacent on the respective sides, the X and Y coordinates are different. Therefore, the pixel devices adjacent on the respective sides are also the pixel devices adjacent on the respective sides in both X- and Y-axis directions.

By considering a pixel device 2a in the ON state, among the pixel devices adjacent to the pixel device 2a, there occurs no optical path length difference between the two pixel devices adjacent on the respective points in the Y-axis direction and the pixel device 2a. Therefore, in the submodulation pattern MP21, the two pixel devices adjacent on the respective points in the Y-axis direction are controlled so that they can be in the ON state as with the pixel device 2a.

The remaining six adjacent pixel devices make optical path length differences with the pixel device 2a. Although the optical path length difference increases in proportion to the distance between the centers of the pixel devices, the distribution of the diffractive light which causes interference attenuates more with respect to the distance. Therefore, the light from the four pixel devices adjacent on the respective sides and having shorter distance between the centers of the pixel devices interferes with the light from the pixel device 2a stronger than the light from the two pixel devices adjacent in the X-axis direction. In the submodulation pattern MP21, the four pixel devices adjacent on the respective sides are controlled so that they can be in the OFF state which is different from the state of the pixel device 2a, and the two pixel devices adjacent in the X-axis direction is controlled so that they can be in the ON state.

The submodulation pattern MP22 exemplified in FIG. 3B is obtained by inverting the submodulation pattern MP21 exemplified in FIG. 3A. That is, in the submodulation pattern MP22, as with the submodulation pattern MP21, the four pixel devices adjacent on the respective sides to the pixel device 2 in the ON state are controlled so that they can enter the OFF state.

The pixel device which is in the OFF state in the modulation pattern MP1 is always in the OFF state in both the submodulation patterns MP21 and MP22.

Thus, in the submodulation pattern exemplified in FIGS. 3A and 3B, the adjacent pixel devices on the side of the highest interference are controlled so that they can be prevented from simultaneously entering the ON state by controlling the four pixel devices adjacent on the respective sides to the pixel device 2 in the ON state so that they can be in the OFF state. Thus, the degradation of the radiation pattern by interference can be suppressed while minimizing the number of submodulation patterns.

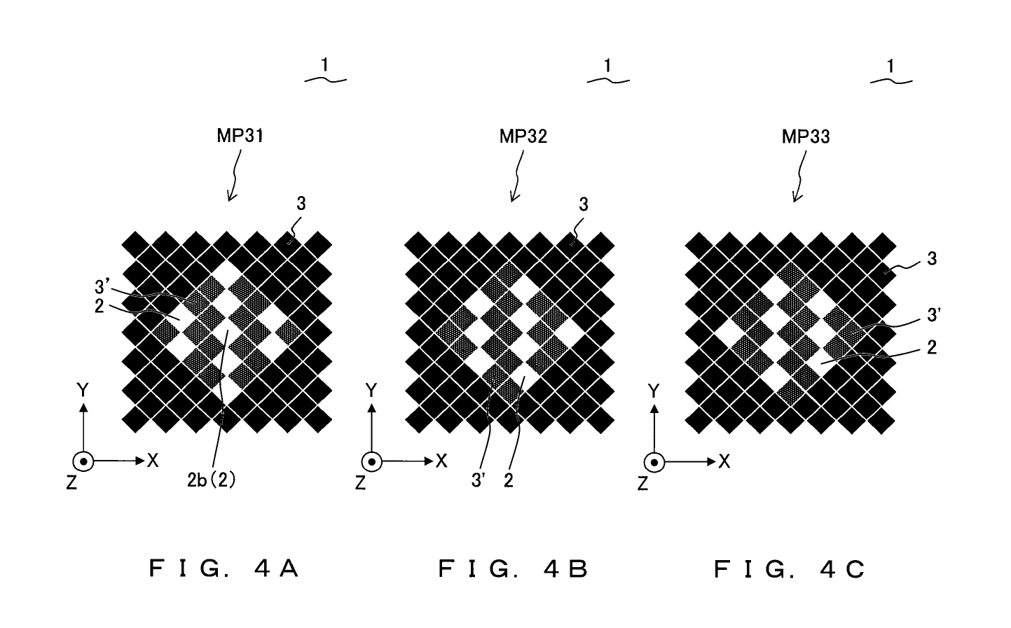

FIGS. 4A through 4C are examples of the submodulation patterns generated by dividing the modulation pattern MP1 exemplified in FIG. 2 into three parts. FIG. 4A exemplifies a submodulation pattern MP31, and FIG. 4B exemplifies a submodulation pattern MP32, and FIG. 4C exemplifies a submodulation pattern MP33.

First, the submodulation pattern MP31 exemplified in FIG. 4A is described. By considering a pixel device 2b in the ON state, among the pixel devices adjacent to the pixel device 2b, there occurs no optical path length difference between the two pixel devices adjacent on the respective points in the Y-axis direction and the pixel device 2b. Therefore, in the submodulation pattern MP31, the two pixel devices adjacent to the pixel device 2b on the respective points in the Y-axis direction are controlled so that they can be in the ON state as with the pixel device 2b.

The remaining six adjacent pixel devices make optical path length differences with the pixel device 2b. Therefore, in the submodulation pattern MP31, all of the six adjacent pixel devices are controlled so that they can be in the OFF state unlike the pixel device 2b.

In the submodulation pattern MP32 exemplified in FIG. 4B, a part of the pixel devices set in the OFF state in the submodulation pattern MP31 exemplified in FIG. 4A are controlled so that they are in the ON state, and as with the submodulation pattern MP31, the pixel device adjacent in the direction other than the Y-axis direction with respect to the pixel device are in the OFF state. In the submodulation pattern MP33 exemplified in FIG. 4C, only the pixel device set in the OFF state in both the submodulation pattern MP31 exemplified in FIG. 4A and a submodulation pattern MP32 exemplified in FIG. 4B is set in the ON state. That is, in the submodulation patterns MP32 and MP33, as with the submodulation pattern MP31, the four pixel devices adjacent on the respective sides to the pixel device 2 and the two pixel devices adjacent in the X-axis direction are controlled so that they enter the OFF state.

The pixel device in the OFF state in the modulation pattern MP1 is in the OFF state in any of the submodulation patterns MP31, MP32, and MP33.

Thus, in the submodulation pattern exemplified in FIGS. 4A through 4C, six pixel devices among which optical path length differences occur in the eight pixel devices adjacent to the pixel device 2 in the ON state are controlled so that they enter the OFF state, thereby controlling the adjacent pixel devices between which interference occurs so that they can be prevented from simultaneously entering the ON state. Thus, the degradation of a radiation pattern by the interference can be more effectively prevented than the submodulation pattern exemplified in FIG. 3.

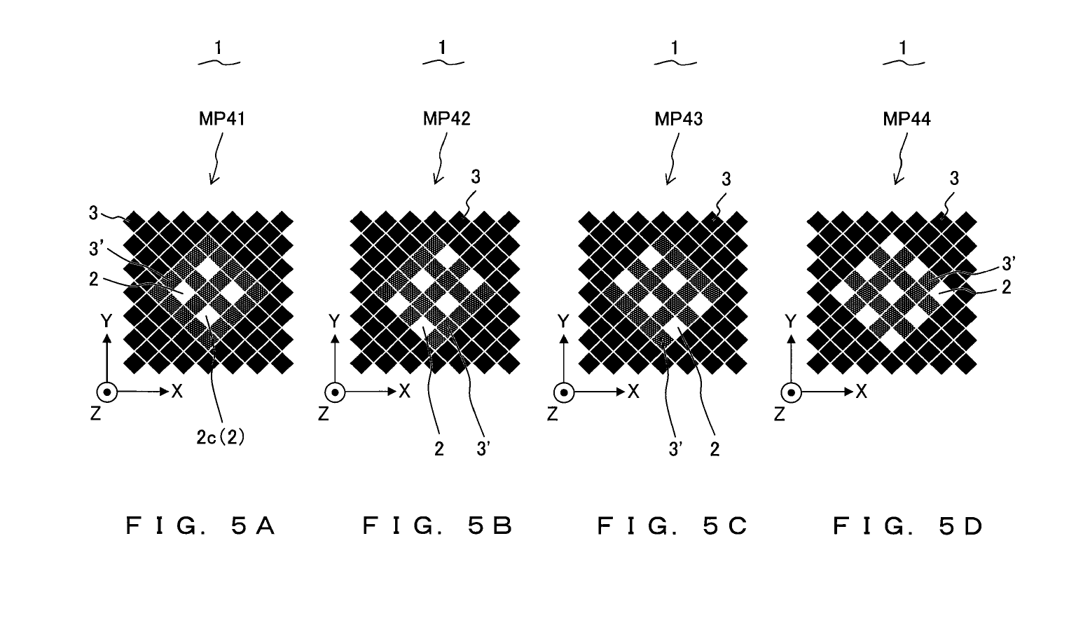

FIGS. 5A through 5D are examples of a submodulation pattern generated by dividing the modulation pattern MP1 exemplified in FIG. 2 into four parts. In FIG. 5A, a submodulation pattern MP41 is exemplified. In FIG. 5B, a submodulation pattern MP42 is exemplified. In FIG. 5C, a submodulation pattern MP43 is exemplified. In FIG. 5D, a submodulation pattern MP44 is exemplified.

First, the submodulation pattern MP41 exemplified in FIG. 5A is described below. When the pixel device 2c in the ON state is considered, the eight pixel devices adjacent to the pixel device 2c are all controlled so that they are in the OFF state unlike the pixel device 2c.

The submodulation pattern MP42 exemplified in FIG. 5B is a submodulation pattern in which a part of the pixel devices in the pixel devices controlled so that they are in the OFF state in the submodulation pattern MP41 exemplified in FIG. 5A are controlled so that they can be in the ON state, and all pixel devices adjacent to the pixel devices in the ON state are in the OFF state as with the submodulation pattern MP41. The submodulation pattern MP43 exemplified in FIG. 5C is a submodulation pattern in which a part of the pixel devices in the pixel devices controlled so that they are in the OFF state in the submodulation pattern MP41 exemplified in FIG. 5A and the submodulation pattern MP42 exemplified in FIG. 5B can be controlled so that they are in the ON state, and all pixel devices adjacent to the pixel devices in the ON state can be in the OFF state as with the submodulation pattern MP41. The submodulation pattern MP44 exemplified in FIG. 5D is a submodulation pattern in which only the pixel devices controlled so that they can be in the OFF state in all the submodulation pattern MP41 exemplified in FIG. 5A and the submodulation pattern MP42 exemplified in FIG. 5B and the submodulation pattern MP43 exemplified in FIG. 5C is controlled so that they can be in the ON state. That is, in the submodulation patterns MP42, MP43, and MP44, the eight pixel devices adjacent to the pixel device 2 in the ON state are controlled so that they can be in the OFF state as with the submodulation pattern MP41.

The pixel devices in the OFF state in the modulation pattern MP1 is constantly in the OFF state in any of the submodulation patterns MP41, MP42, MP43, and MP44.

Thus, in the submodulation patterns exemplified in FIGS. 5A through 5D, By controlling the eight pixel devices adjacent to the pixel device 2 in the ON state so that they can be in the OFF state, the pixel devices adjacent to the pixel device 2 in the ON state in which interference arises are controlled so that they are not simultaneously in the ON state. Thus, as with the submodulation patterns exemplified in FIGS. 4A through 4C, the degradation of the radiation pattern by the interference can be effectively suppressed.

As described above, the degradation of the radiation pattern by the interference can be suppressed by dividing a target modulation pattern MP1 into a plurality of submodulation patterns and sequentially controlling the DMD 1 in each of the plurality of submodulation patterns. The effect is not limited to the illuminating light of a specific wavelength. Since the degradation of the pattern of illuminating light of any wavelength can be suppressed, a target can be irradiated with the light of a desired pattern independent of the wavelength of light. Furthermore, the effect is not limited to the case in which the target is on the focal surface. That is, it is effective also when the target is positioned in a place out of focus with respect to the focal surface.

The submodulation pattern is not limited to those exemplified in FIGS. 3A, 3B, 4A through 4C, and 5A through 5D. It is desirable that a submodulation pattern to be used is determined based on the optical characteristic of the projection optical system for projecting a submodulation pattern on a sample. Concretely, it is desired that, using a point spread function (PSF) of the projection optical system, the interval between the pixel devices in which the interference of the illuminating light arising on a sample can be sufficiently suppressed is calculated, based on which a submodulation pattern is determined.

Generally, when the number of divided parts increases, the interval between the pixel devices in the ON state becomes larger. Therefore, it is effective in suppressing interference. However, there can occur the case in which the use efficiency of illuminating light is degraded and the processing time becomes longer. In addition, a higher-speed operation of the DMD 1 can be demanded. Therefore, it is preferable to divide a modulation pattern by the minimal number of divisions based on the PSF.

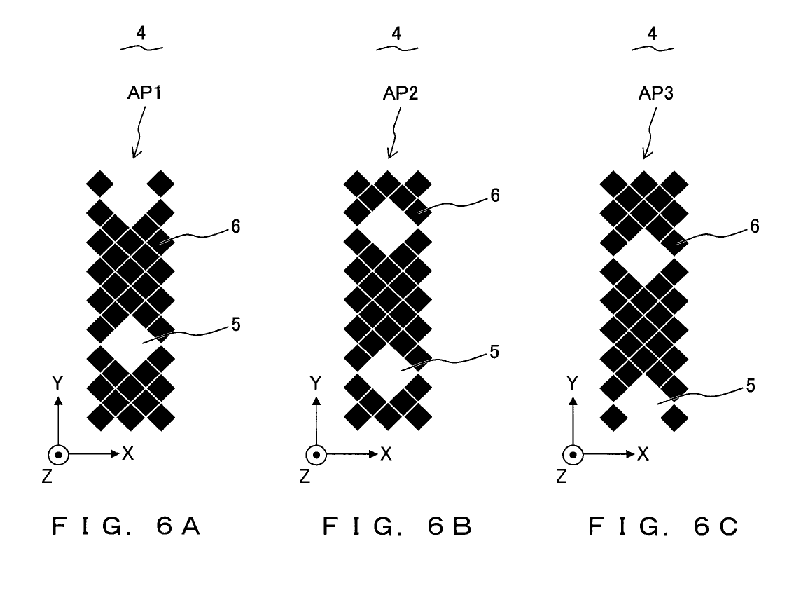

FIGS. 6A through 6C are examples of aperture patterns of the DMD according to an embodiment of the present invention. The XYZ coordinates system in the figures is provided for convenience of direction reference. In this example, the Z axis indicates the perpendicular direction, and the XY plane indicates the horizontal plane. A DMD 4 is arranged on the XY plane.

The DMD 4 is included in the scanning confocal microscope, and includes a plurality of pixel devices each independently modulating light. The DMD 4 is arranged between the light source and the sample, and is arranged in an optically conjugate position to the sample. Therefore, it is similar to the DMD 1 in that the sample is projected with the ON/OFF pattern of the pixel devices as is. That is, the scanning confocal microscope is a type of pattern projection apparatus. However, the DMD 4 also works on the detection light (for example, fluorescence etc.) generated from a sample, and functions as a confocal stop. The modulation pattern of the DMD 4 functioning as a confocal stop is hereinafter referred to as an aperture pattern (or a subaperture pattern).

In FIGS. 6A through 6C, the DMD 4 is controlled for an aperture pattern in which two confocal apertures are formed for detection by simultaneous radiation of two points on the sample. A pixel device 5 indicates a device in the ON state, and a pixel device 6 indicates a device in the OFF state. Each of the two confocal apertures is formed by four pixel devices 5. Although described later, the aperture pattern of the DMD 4 is not determined using the radiation control such as a pattern of the illuminating light radiated onto the sample unlike the modulation pattern of the DMD 1, but determined based on the detection condition such as the detection efficiency of the detection light generated from the sample, etc.

The DMD 4 functions also as a scanning unit. FIGS. 6A, 6B, 6C, illustrate aperture patterns AP1, AP2, and AP3 of the DMD 4 in a time series at different time points, and illustrate the states in which the aperture patterns (confocal aperture) are shifted by one pixel device in the Y (−) direction.

Since the DMD 4 functioning as the confocal stop simultaneously controls the plurality of adjacent pixel devices so that they can be in the ON state, there occur optical path length differences among the pixel devices. Therefore, the radiation pattern is degraded by mutual interference among different beams of illuminating light deflected the pixel devices in which an optical path length difference occurs.

Therefore, the aperture pattern of the DMD 4 functioning as the confocal stop is divided into a plurality of subaperture patterns, and the DMD 4 is controlled in order for each of the plurality of subaperture pattern with respect to each scanning position. That is, the radiation pattern is realized by combining subaperture patterns instead of a aperture pattern.

Since the illuminating light modulated (deflected) by different subaperture patterns is radiated onto a sample with different timings, the beams of illuminating light do not interfere with one another. Therefore, controlling the combination of subaperture patterns can suppress the degradation of the radiation pattern by the interference among the beams of illuminating light as compared with the control of the aperture patterns before the division.

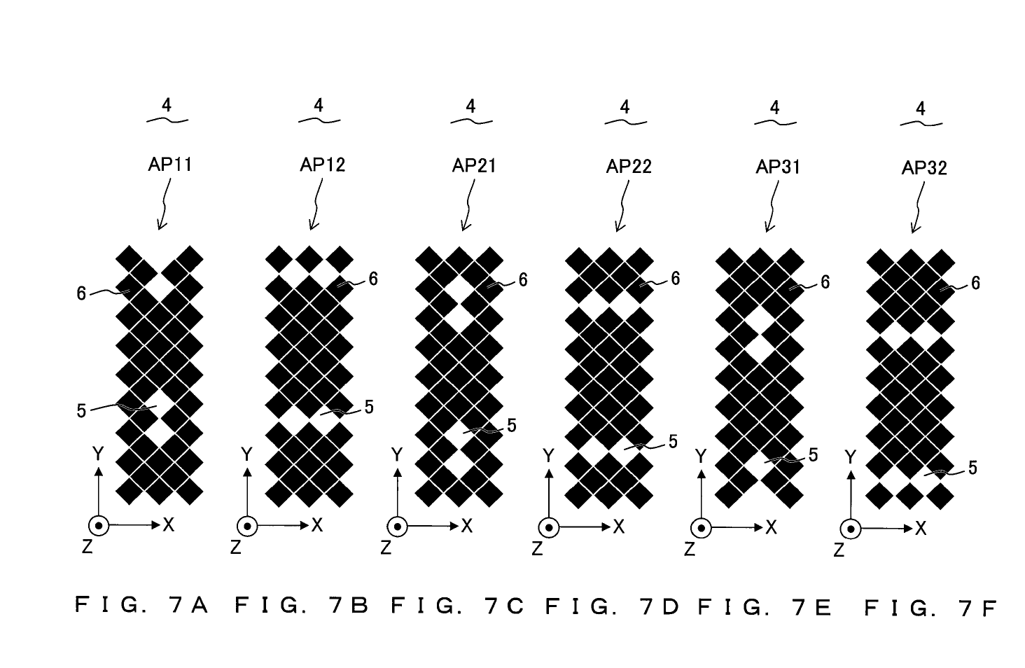

An effective subaperture pattern for suppression of degradation of a radiation pattern is concretely described below with reference to FIGS. 7A through 7F. In FIGS. 7A through 7F, the illuminating light enters parallel to the XZ plane. Therefore, the optical path length difference occurs among the pixel devices different in the X coordinates (to be strict, the illuminating light deflected among the pixel devices), and does not occur among the pixel devices different only in the Y coordinates. That is, in FIGS. 7A and 7F, the direction in which the optical path length difference occurs is the X direction, and the direction in which no optical path length difference occurs is the Y direction.

FIGS. 7A through 7F are examples of subaperture patterns generated by dividing the aperture pattern exemplified in FIGS. 6A through 6C into two parts. FIGS. 7A and 7B respectively exemplify subaperture patterns AP11 and AP12 obtained by dividing the aperture pattern AP1 exemplified in FIG. 6A. FIGS. 7C and 7D respectively exemplify subaperture patterns AP21 and AP22 obtained by dividing the aperture pattern AP2 exemplified in FIG. 6B. FIGS. 7E and 7F respectively exemplify subaperture patterns AP31 and AP32 obtained by dividing the aperture pattern AP3 exemplified in FIG. 6C.

In any subaperture pattern, by controlling the pixel devices adjacent with the pixel device 5 in the ON state on the sides in the X direction so that they can enter the OFF state, the pixel devices adjacent to the pixel device 5 on the sides having highest interference with each other are controlled so that they cannot simultaneously enter the ON state. Thus, as with the control exemplified in FIGS. 3A and 3B, the degradation of the radiation pattern by interference can be suppressed while minimizing the number of subaperture patterns. In this case, each of the subaperture patterns does not overlap each other by the parallel movement in the X direction in which an optical path length difference occurs.

Thus, the degradation of the radiation pattern by the interference can be suppressed by dividing an aperture pattern of the DMD 4 functioning as a confocal stop into a plurality of subaperture patterns and sequentially controlling the DMD 4 in each of the plurality of subaperture patterns with respect to each scanning position.

The effect is not limited to the illuminating light of a specific wavelength. Since the degradation of the pattern of illuminating light of any wavelength can be suppressed, a target can be irradiated with the light of a desired pattern independent of the wavelength of light. Furthermore, the effect is not limited to the case in which the target is on the focal surface. That is, it is effective also when the target is positioned in a place out of focus with respect to the focal surface.

The subaperture pattern is not limited to the subaperture pattern exemplified in FIGS. 7A through 7F. For example, as with the control exemplified in FIGS. 4A through 4C, an aperture pattern can be divided into three parts, and the pixel device adjacent to the pixel device 5 in the ON state on the respective sides in the X-axis direction and the pixel device adjacent to the pixel device 5 in the ON state on the respective points in the X-axis direction can be controlled so that they enter the OFF state.

As with the submodulation pattern, it is desired that the subaperture pattern to be used is determined based on the interval between the pixel devices, for which the interference of the illuminating light occurring on a sample can be sufficiently suppressed, calculated using the point spread function (PSF) of the projection optical system.

In addition, since the DMD 4 is included in the scanning confocal microscope, the aperture pattern before the division is not determined by the shape of the sample or the shape of a radiation target area. It is desired that the aperture pattern is determined by considering that the DMD 4 works on the detection light generated from the sample.

To be concrete, for example, it can be determined based on the magnification of an objective included in an projection optical system and the exit pupil diameter (when the light enters from the sample side). Generally, when the magnification of an objective is low, the exit pupil diameter is large, and the numerical aperture on the exit side is also large. Therefore, the Airy disc diameter of the light condensed on the DMD 4 becomes small. Accordingly, an aperture pattern having a relatively small confocal aperture can be attained.

On the other hand, when the magnification of an objective is high, the exit pupil diameter is small, and the numerical aperture on the exit side is also small. Therefore, the Airy disc diameter of the light condensed on the DMD 4 becomes large. Accordingly, it is necessary to generate an aperture pattern having a relatively large confocal aperture because, when a confocal aperture is small, the detection light which has spread by diffraction is interrupted, and a sufficient amount of detection light cannot be led to a detector.

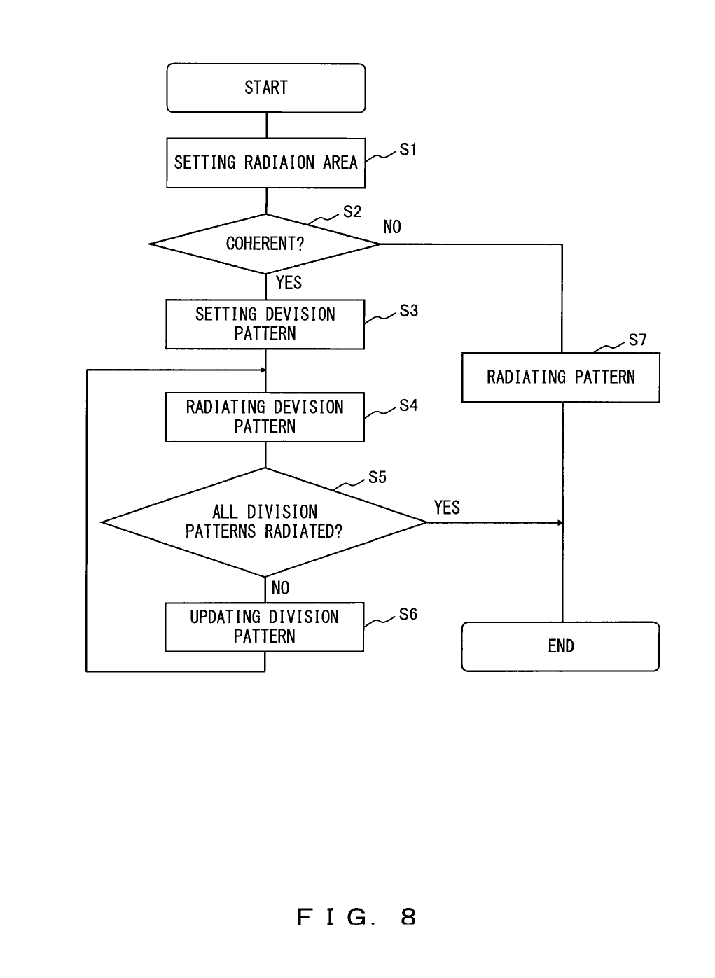

Next, the flow of the control of the pattern projection apparatus including the above-mentioned DMD 1 and the DMD 4 is described below with reference to FIG. 8. FIG. 8 is a flowchart of an example of the control of the pattern projection apparatus including the DMD according to an embodiment of the present invention.

When the control of the pattern projection apparatus for irradiating an object with the light of a desired pattern is started, a radiation area is first set (step S1). To be concrete, a modulation pattern and an aperture pattern are set. For example, a modulation pattern is set based on the shape of a sample and the shape of an area to be irradiated on the sample, and an aperture pattern is set based on the magnification and the exit pupil diameter of the objective included in an projection optical system and a wavelength to be used. When the pattern projection apparatus is a scanning confocal microscope, a scanning range can further be set.

In step S2, the coherence in the modulation pattern (aperture pattern) set in step S1 is determined. The determination of coherence is, for example, made by calculating the interval between pixel devices allowed using the point spread function PSF of the projection optical system (hereinafter referred to as an allowed interval), and comparing the calculation result with the minimum interval between the pixel devices controlled so that they are in the ON state.

When no coherence is determined in step S2, (for example, when the allowed interval is equal to or lower than the minimum interval), control is passed to step S7, and the DMD is controlled so that it can enter the modulation pattern set in step S1. Thus, the modulation pattern is projected on the sample, and the sample is irradiated with a predetermined radiation pattern. When the pattern projection apparatus is a scanning confocal microscope, the process in step S7 is performed for each scanning position, thereby terminating the control.

When the existence of coherence is determined in step S2 (for example, when the allowed interval exceeds the minimum interval), control is passed to step S3. In step S3, a division pattern (submodulation pattern, subaperture pattern) is set.

For example, the division pattern is determined based on the allowed interval between the pixel devices calculated using the point spread function PSF of the projection optical system.

In steps S4, S5, and S6, the DMD is controlled in order of division pattern set in step S3. Thus, the sample is irradiated sequentially with the light of the radiation pattern corresponding to the division pattern, and the entire sample is irradiated with the light of a desired radiation pattern.

When the pattern projection apparatus is a scanning confocal microscope, the processes in steps S4 through S6 are performed for each scanning position. When all division patterns are radiated, control is terminated

By controlling the pattern projection apparatus as described above, the light of a predetermined pattern can be radiated on a target independent of the wavelength of the light. In FIG. 8, a step of determining the coherence (step S2) is provided, but the step can be omitted and a pattern can be constantly divided.

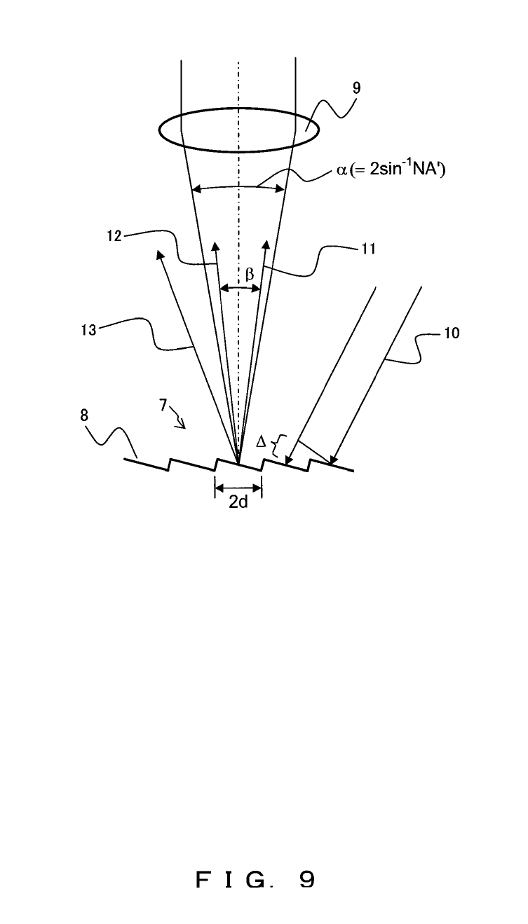

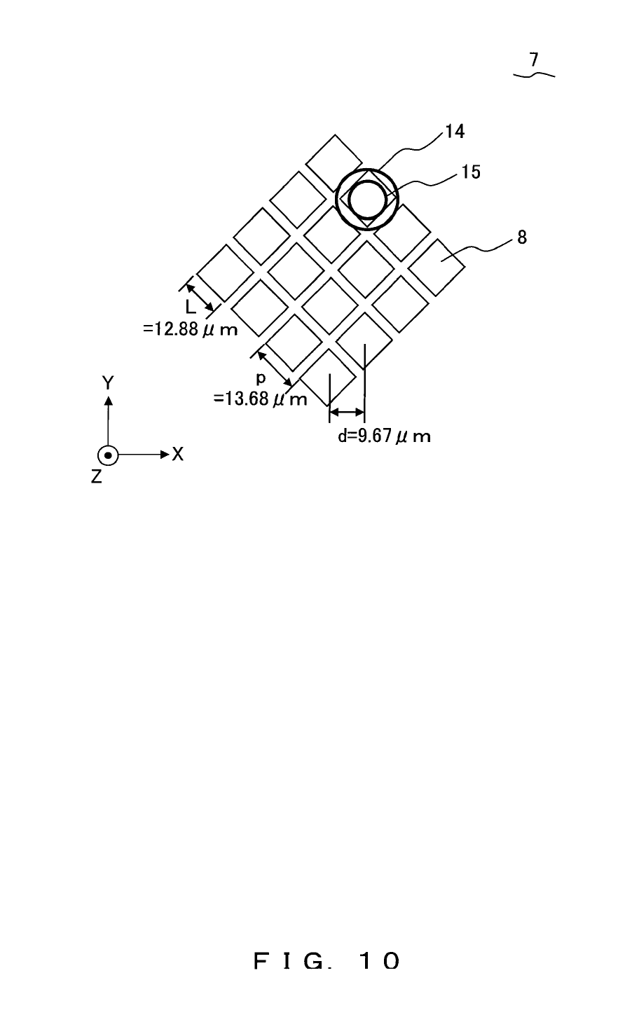

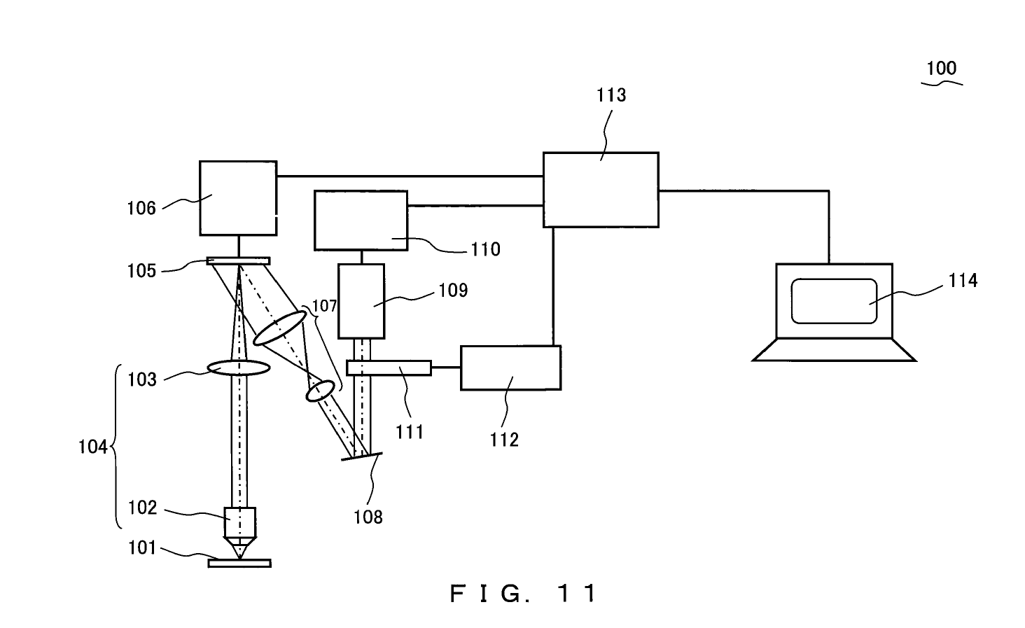

Next, a preferable characteristic of an optical system for taking light modulated by a DMD is described below. FIG. 9 illustrates the state in which the DMD functions as a diffraction grating. Since a DMD 7 in which a plurality of pixel devices 8 are arranged functions as a diffraction grating as exemplified in FIG. 9, discrete diffractive light (diffractive light 11, 12, and 13) is independently generated when incident light 10 enters the DMD 7. Therefore, when the numerical aperture on the DMD 7 side of an projection optical system 9 is not appropriate, the projection optical system 9 cannot sufficiently takes in the diffractive light generated from the pixel device 8, thereby largely degrading the use efficiency of the light.

Therefore, it is desired that the numerical aperture on the DMD 7 side of the projection optical system 9 is sufficiently large, and that the numerical aperture is determined by considering that the direction in which the diffractive light is generated is changed by the pitch d in the diagonal direction of the pixel device 8 and the wavelength of the incident light 10. To be concrete, it is desired that the numerical aperture of the DMD 7 side of the projection optical system 9 exceeds the numerical aperture depending on the Airy disc diameter in the wavelength of the incident light (illuminating light) and corresponding to the size of the pixel device. To be more concrete, it is desired that the Airy disc diameter is equal to or smaller than the diameter of the circumcircle for the pixel device, and it is more preferable that the diameter is equal to or smaller than the diameter of the inscribed circle for the pixel device.

Generally, it is known that there is the relationship of D=1.22λ/NA among the Airy disc diameter D, the wavelength λ, and the numerical aperture NA. By the numerical aperture on the DMD 7 side of the projection optical system 9 satisfying the above-mentioned condition, an acceptable light use efficiency can be guaranteed, and a high resolution for resolving a pixel device can be realized. When plural beams of illuminating light different in wavelength are used, it is preferable that the numerical aperture is determined based on the illuminating light having the longest wavelength.

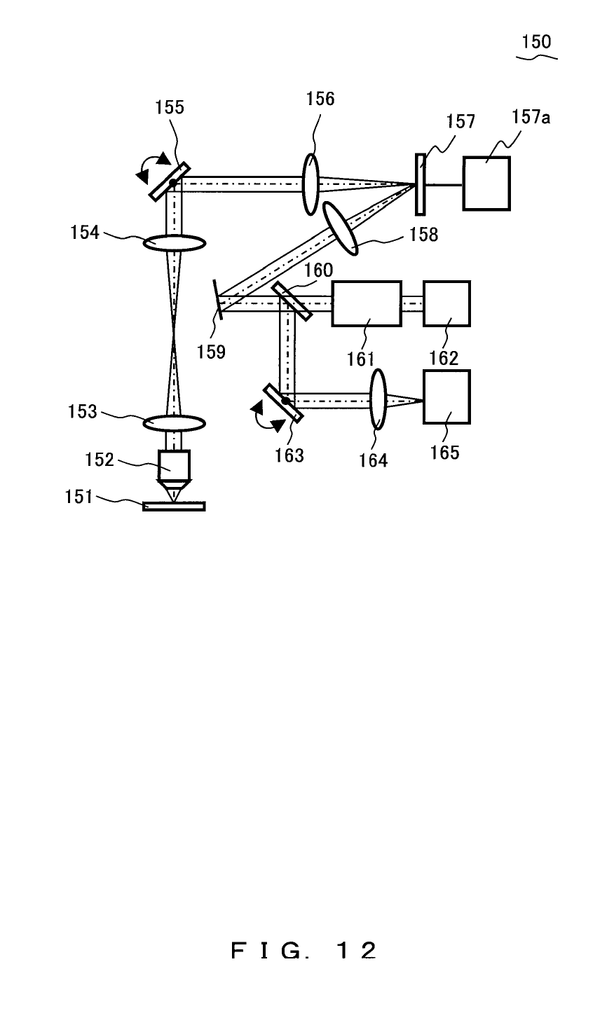

For example, a study is made of a case in which the DMD 7 prepared such that the pixel device 8 having a side length L of 12.88 μm as exemplified in FIG. 10 is arranged with the pitch d of 9.67 μm in the diagonal direction and the pitch p of 13.68 μm in the side direction is irradiated with a laser light (illuminating light) having a wavelength of 525 nm. In this case, to make the Airy disc diameter D equal to or less than the diameter of a circumcircle 14 for the pixel device 8, the numerical aperture on the DMD 7 side of the projection optical system 9 is to be about 0.035 or more. Furthermore, to make it equal to or less than the diameter of an inscribed circle for the pixel device 8, the numerical aperture on the DMD 7 side of the projection optical system 9 is to be about 0.05 or more.

In addition, when the DMD also works on the detection light generated from the sample, it is desired that the detection optical system arranged between the DMD and the photodetector has a similar characteristic.

To be concrete, it is desired that the numerical aperture on the DMD side of the detection optical system is equal to or exceeds the numerical aperture corresponding to the size of the pixel device and determined by the Airy disc diameter in the wavelength of the incident light (detection light). To be more concrete, it is desired that the Airy disc diameter is equal to or less than the diameter of the circumcircle for the pixel devices, and it is more preferable that it is equal to or less than the diameter of the inscribed circle for the pixel devices.

The description above is made with reference to a digital micromirror device (DMD) as a spatial light modulator, but the spatial light modulator is not limited to this application. That is, a spatial light modulator can be a device in which an optical path length difference occurs between the pixel devices.

### Embodiment 1

FIG. 11 illustrates the outline of the configuration of the laser repair device according to the present embodiment.

A laser repair device 100 exemplified in FIG. 11 is a kind of pattern projection apparatus, and includes a DMD 105 having a plurality of pixel devices each independently modulating light.

The laser repair device 100 includes an projection optical system 104 having an objective 102 and a tube lens 103, a DMD 105 arranged in an optically conjugate position with respect to a work 101, a DMD drive device 106 for controlling the pattern of the DMD 105, an optical relay system 107 for irradiating all pixel devices of the DMD 105 with laser light, a mirror 108 for reflecting the laser light in the direction of a predetermined angle with respect to the DMD 105, a laser light source 109 for emitting the laser light, a laser drive device 110 for controlling the laser light source 109, a shutter 111, a shutter drive device 112 for controlling opening and closing the shutter 111, a submodulation pattern generation device 113 for generating a plurality of submodulation patterns from a modulation pattern corresponding to a target radiation pattern, and a modulation pattern input device 114 for inputting a modulation pattern corresponding to a target radiation pattern.

The DMD drive device 106, the laser drive device 110, the shutter drive device 112, the submodulation pattern generation device 113, and the modulation pattern input device 114 configure a control device of the laser repair device 100.

In the laser repair device 100, the DMD 105 is controlled for each of a plurality of submodulation patterns obtained by dividing a modulation pattern for radiating the laser light of a target shape on the work 101 as the DMD 1 exemplified in FIGS. 3A, 3B, 4A through 4C, and 5A through 5D by the control device. Thus, the interference between the beams of laser light on the work 101 is suppressed, and a desired radiation pattern is realized.

To be more concrete, in the laser repair device 100, a user inputs a modulation pattern corresponding to a desired radiation pattern to the modulation pattern input device 114 to process a faulty part etc. of the work 101. Therefore, the submodulation pattern generation device 113 divides the input modulation pattern into a plurality of submodulation patterns for suppressing the degradation of the radiation pattern. The generated submodulation patterns are output to the DMD drive device 106, and the DMD drive device 106 sequentially controls the DMD 105 to each of the plurality of submodulation patterns. Thus, the submodulation patterns of the DMD 105 which the laser light enters through the mirror 108 and the optical relay system 107 are sequentially projected onto the work 101 by projection optical system. As a result, the interference between the beams of the laser light is suppressed.

It is desired that the intervals among the pixel devices for which the interference of the laser light generated on the work 101 can be sufficiently suppressed are calculated using the point spread function of the projection optical system 104 as described above, and the submodulation patterns generated by the submodulation pattern generation device 113 are determined based on the intervals. For example, the submodulation patterns can be those for controlling the four pixel devices adjacent on the respective sides in the direction of occurring an optical path length difference with the pixel device in the ON state as exemplified in FIGS. 3A and 3B so that the pixel devices can enter the OFF state, and can also be the patterns for controlling the six pixel devices which generate an optical path length difference (that is, adjacent in the direction of generating an optical path length difference) in the eight pixel devices adjacent to the pixel device in the ON state as exemplified in FIGS. 4A through 4C so that the pixel devices can enter the OFF state. They can also be those for controlling all of the eight pixel devices adjacent to the pixel device in the ON state as exemplified in FIGS. 5A through 5D so that they can enter the OFF state.

In addition, it is desired that the numerical aperture of the DMD 105 side of the tube lens 103 (projection optical system 104) is somewhat large, and it is desired that the numerical aperture equals or exceeds the numerical aperture determined depending on the Airy disc diameter in the wavelength of the laser light (illuminating light) and corresponding to the size of the pixel devices. In this case, it is desired that the Airy disc diameter is equal to or less than the diameter of the circumcircle for the pixel devices, and is equal to or less than the diameter of the inscribed circle for the pixel devices.

As described above, the laser repair device 100 can suppress the degradation of a radiation pattern by interference. Furthermore, it allows the work 101 irradiated with laser light of any wavelength as the light of a desired pattern without depending on the wavelength of the laser light. In addition, it is also effective when the work 101 is positioned in a place out of focus with respect to the focal surface. Furthermore, the laser light (diffractive light) generated from the pixel device of the DMD 105 can be sufficiently taken in by increasing the numerical aperture on the DMD 105 side of the tube lens 103, thereby realizing a high use efficiency of light.

### Embodiment 2

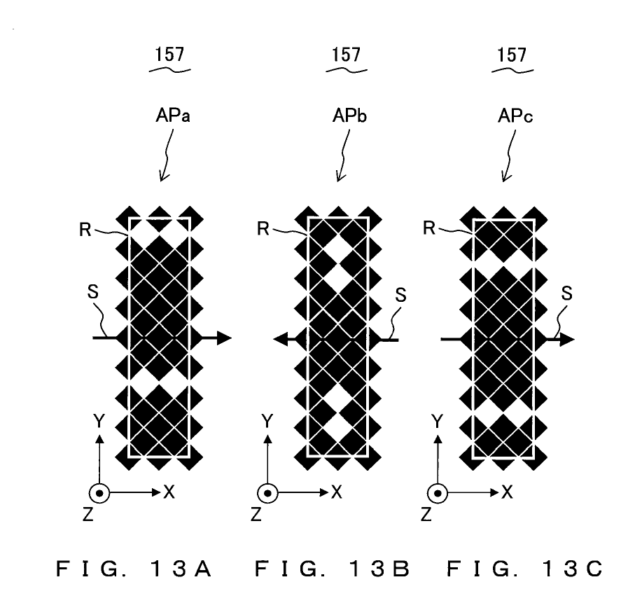

FIG. 12 is the outline exemplifying the configuration of the scanning confocal microscope according to the present embodiment. A scanning confocal microscope 150 exemplified in FIG. 12 is a type of pattern projection apparatus, and includes a DMD 157 having a plurality of pixel devices each independently modulating light.

The scanning confocal microscope 150 is configured by an objective 152 for irradiating a sample 151 with illuminating light and taking in detection light (for example, fluorescence) generated from the sample 151, a tube lens 153 for forming an image with the detection light emitted from the objective 152, a pupil projection lens 154 designed according to the exit pupil diameter of the objective 152, a Galvano mirror 155 for scanning the sample 151 in the X-axis direction orthogonal to the optical axis of the objective 152, a lens 156 (first lens) for condensing detection light on the DMD 157, a DMD 157 arranged at an optically conjugate position with respect to the sample 151 and functioning as a confocal stop, a control device 157a for controlling the DMD 157, a lens 158 for converting the detection light from the DMD 157 into parallel light, a mirror 159 for reflecting the detection light toward a dichroic mirror 160, the dichroic mirror 160 for passing illuminating light and reflecting the detection light, a line illumination optical system 161 converting the light into illuminating light of uniform intensity and of a linear sectional shape, a light source 162 for emitting illuminating light, a Galvano mirror 163 for deflecting the detection light in synchronization with the operation of the Galvano mirror 155, an imaging lens 164 for condensing the detection light on a CCD 165, and the CCD 165 for detecting the detection light.

The light source 162 can be, for example, a lamp light source and a laser light source. In addition, the line illumination optical system 161 is an optical system including at least one Powell lens, an optical system including at least one cylindrical lens, or an optical system including at least one lens array.

First described briefly is the flow of radiating the illuminating light emitted from the light source 162 on the sample 151, and detecting by the CCD 165 the detection light generated from the sample 151 in the scanning confocal microscope 150.

The illuminating light emitted from the light source 162 is converted into linear illuminating light by the line illumination optical system 161, passes through the dichroic mirror 160, and enters the mirror 159. The mirror 159 reflects the illuminating light in the direction of a predetermined angle with respect to the DMD 157. The illuminating light reflected by the mirror 159 is linearly condensed on the DMD 157 by the lens 158 in the longitudinal direction orthogonal to the surface of the figure. In the DMD 157, only a pixel device as a confocal aperture with respect to the detection light is controlled so that it is placed in the ON state. The illuminating light which has entered the pixel device in the ON state in the DMD 157 is emitted toward the lens 156, and enters the objective 152 through the Galvano mirror 155, the pupil projection lens 154, and the tube lens 153. The objective 152 condenses the illuminating light on the sample 151 to generate detection light.

The detection light generated from the sample 151 enters the objective 152. Then, it passes the same route as the illuminating light in the opposite direction and enters the DMD 157. Since the DMD 157 functions as a confocal stop, only the detection light generated from the position where the illuminating light is condensed is emitted toward the lens 158. Then, the detection light emitted from the DMD 157 enters the dichroic mirror 160 through the lens 158 and the mirror 159. The dichroic mirror 160 has the property of reflecting the detection light. Therefore, the detection light is reflected by the dichroic mirror 160, and enters the imaging lens 164 through the Galvano mirror 163. The detection light is condensed by the imaging lens 164 on the CCD 165, and detected by the CCD 165.

In the scanning confocal microscope 150, the Galvano mirror 155 for scanning on the sample 151 by a reciprocating motion functions as a scanning unit in the X-axis direction, and the DMD 157 functions as a scanning unit in the Y-axis direction by moving the position of the confocal aperture in the aperture pattern in the longitudinal direction. That is, the scanning confocal microscope 150 performs a two-dimensional scanning on the sample 151 using the Galvano mirror 155 and the DMD 157, and furthermore performs scanning in the Z-axis direction by a mechanism of moving a stage on which the work 101 is placed or a mechanism of moving the objective 102 although they are not illustrated in the attached drawings.

The Galvano mirror 163 also deflects the detection light in the X-axis direction in synchronization with the operation of the Galvano mirror 155. Thus, the condensing position in the CCD 165 of the detection light can be changed corresponding to the condensing position on the sample 151 of the illuminating light.

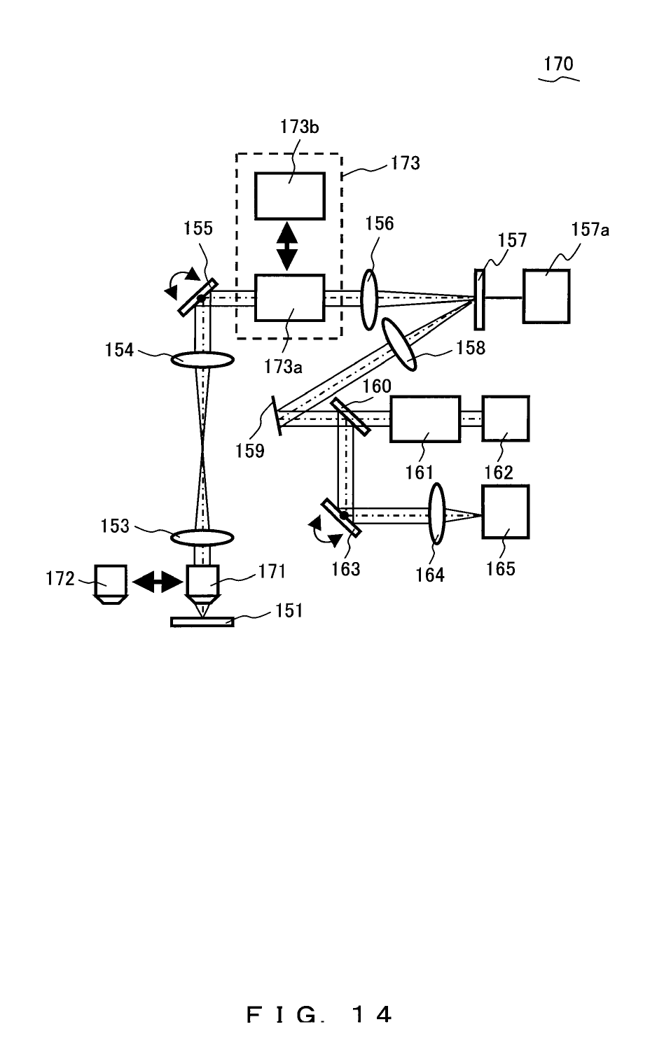

In the scanning confocal microscope 150, the DMD 157 is controlled by the control device 157a for each scanning position, as with the DMD 4 exemplified in FIGS. 7A through 7F, for each of the plurality of subaperture patterns obtained by dividing the aperture pattern of a confocal stop. In addition, as exemplified in FIGS. 13A through 13C, the plurality of subaperture patterns obtained by dividing the aperture pattern can be assigned to the outgoing and incoming scanning paths by the Galvano mirror 163.

FIGS. 13A through 13C are examples of the aperture subpatterns used in the scanning confocal microscope 150, and illustrate the state in which the illuminating light is radiated on a linear area R in the Y-axis direction of the DMD 157 as a longitudinal direction. The DMD 157 is controlled in the order of a subaperture pattern APa exemplified in FIG. 13A, a subaperture pattern APb exemplified in FIG. 13B, and a subaperture pattern APc exemplified in FIG. 13C. In the DMD 157, the subaperture pattern APa and the subaperture pattern APc are assigned to the incoming scanning path by the Galvano mirror 163, and the subaperture pattern APb is assigned to the outgoing scanning path by the Galvano mirror 163 (refer to the scanning direction S).

By the control above, the subaperture patterns of the DMD 157 are sequentially projected on the sample 151 for each scanning position, thereby suppressing the interference between the beams of illuminating light on the sample 151. As a result, a desired radiation pattern can be realized. In addition, the DMD 157 also works on the detection light generated from the sample 151. Therefore, the subaperture patterns of the DMD 157 are sequentially projected on the CCD 165 for each scanning position, thereby suppressing the interference between the beams of detection light. Furthermore, the DMD 157 also functions as a confocal stop controlled for the optimum aperture diameter for the detection light. Therefore, a bright image of s high resolution can be obtained.

It is desired that the aperture pattern is determined by considering the DMD 157 working on the detection light generated from the sample 151. For example, the control device 157a can change the aperture pattern depending on the magnification of the objective 152 between the sample 151 and the DMD 157 or the exit pupil diameter (when light enters from a sample side). When the exit pupil diameter is small, it is desired to use an aperture pattern having a relatively large confocal aperture. Therefore, a sufficient quantity of light of the detection light can be reserved, thereby obtaining a bright image.

In addition, it is desired that a subaperture pattern is determined by calculating the interval between pixel devices for which the interference of the illuminating light generated on the sample 151 is sufficiently suppressed using the point spread function of the projection optical system configured by the objective 152, the tube lens 153, the pupil projection lens 154, and the lens 156. For example, the subaperture pattern can be designed so that the pixel devices adjacent on the sides in the X-axis direction (direction in which an optical path length difference occurs) to the pixel device in the ON state as exemplified in FIGS. 7A through 7F can be in the OFF state.

Furthermore, it is also desired that the numerical aperture on the DMD 157 side of the lens 156 configuring the projection optical system with the pupil projection lens 154, the tube lens 153, and the objective 152 is somewhat large. To be concrete, it is desired that the numerical aperture is equal to or larger than the numerical aperture determined by an Airy disc diameter (first Airy disc diameter) in the wavelength of the illuminating light and corresponding to the size of the pixel device. It is desired that the Airy disc diameter is equal or smaller than the diameter of the circumcircle for the pixel devices, and it is further desired that it is equal or smaller than the diameter of the inscribed circle for the pixel devices. Thus, the illuminating light modulated by the DMD 157 can be sufficiently taken in, and the illuminating light emitted from the light source 162 can be efficiently led to the sample 151.

Furthermore, it is desired that the numerical aperture of the DMD 157 side of the lens 158 configuring detection optical system with the imaging lens 164 is somewhat large. To be concrete, it is desired that the numerical aperture equals or exceeds the numerical aperture determined by the Airy disc diameter (second Airy disc diameter) in the wavelength of the detection light and corresponding to the size of the pixel devices. It is desired that the Airy disc diameter is equal or small than the diameter of the circumcircle for the pixel devices, and it is further desired that the diameter is equal or smaller than the diameter of the inscribed circle for the pixel devices. Thus, since the detection light modulated by the DMD 157 can be sufficiently taken in, the detection light generated on the sample 151 can be efficiently led to the CCD 165. In addition, the resolution of the scanning confocal microscope 150 can be optimized.

It is desired that the imaging lens 164 is designed to have the magnification so that each pixel device of DMD 157 projected on the CCD 165 is smaller than one pixel of the CCD 165. Thus, the resolution of a subaperture pattern in an unintended last image can be suppressed, thereby reducing the streaky unevenness generated on an image.

As described above, the scanning confocal microscope 150 can suppress the degradation of a radiation pattern by interference. In addition, since it does not depend on the wavelength of illuminating light, the illuminating light of any wavelength can be radiated on the sample 151 as light of a desired pattern. In addition, it is effective when the sample 151 is positioned in a place out of focus with respect to the focal surface. Furthermore, the diffractive light generated from the pixel devices of the DMD 157 can be sufficiently taken in by increasing the numerical aperture on the DMD 157 side of the lens 156 and the lens 158, thereby realizing high use efficiency of light.

In FIG. 12, the dichroic mirror 160 which passes illuminating light and reflects detection light is exemplified, but the characteristics of the dichroic mirror 160 are not limited to it. That is, a dichroic mirror can reflect illuminating light and pass detection light. However, when a dichroic mirror which passes illuminating light and reflects detection light is used, the dichroic mirror functions as a parallel plane in parallel luminous flux with respect to the illuminating light. Therefore, the angle of the illuminating light with the mirror 159 is maintained and no aberration is generated. Accordingly, it is a preferable dichroic mirror.

### Embodiment 3

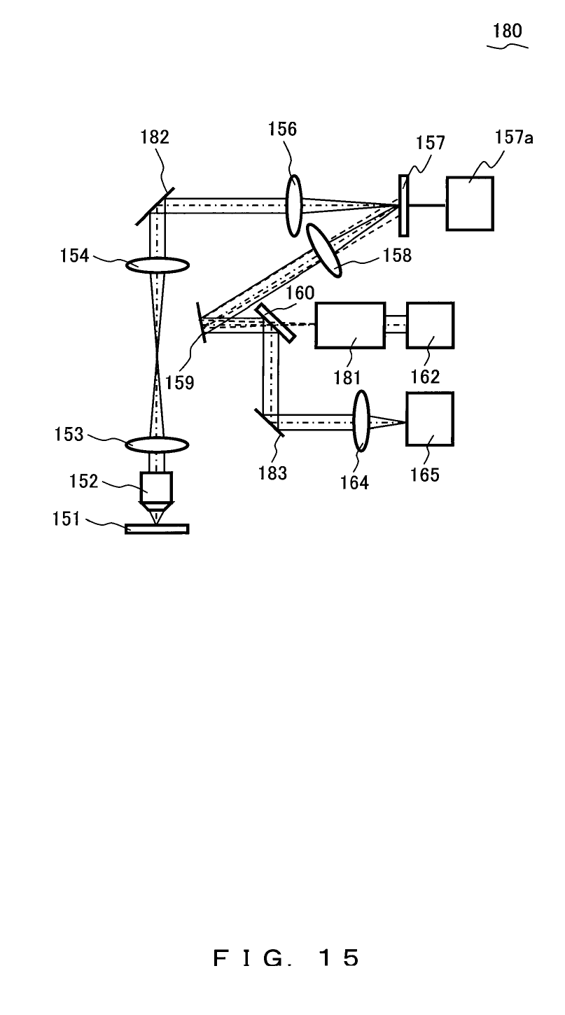

FIG. 14 is the outline exemplifying the configuration of the scanning confocal microscope according to the present embodiment. The scanning confocal microscope 170 exemplified in FIG. 14 is a type of pattern projection apparatus, and includes the DMD 157 having a plurality of pixel devices each independently modulating light.

The scanning confocal microscope 170 is a variation example of the scanning confocal microscope 150 according to the embodiment 2. Therefore, the components common with the scanning confocal microscope 150 are assigned the same reference numerals, and the detailed descriptions are omitted here.

The scanning confocal microscope 170 is different from the scanning confocal microscope 150 according to the embodiment 2 in that it includes in an projection optical system a variable magnification optical system 173 (variable magnification optical systems 173a and 173b) for changing the magnification upon switch of an objective. The variable magnification optical system 173 is arranged between the objective and the lens 156 (first lens) and the predetermined magnification is changed depending on the exit pupil diameter of the objective.

To be more concrete, when an objective 171 is used, the variable magnification optical system 173a having a predetermined magnification depending on the exit pupil diameter of the objective 171 is inserted into an optical path. In addition, when the objective 172 is used, the variable magnification optical system 173b having a predetermined magnification depending on the exit pupil diameter of the objective 172 is inserted into an optical path.

Thus, the optimum illumination according to the exit pupil diameter of the objective is realized. Therefore, the degradation of the illumination efficiency by the vignetting generated by the exit pupil, and the reduction of the resolution on the sample 151 side by not meeting the exit pupil diameter with light can be prevented. Furthermore, since the variable magnification optical system 173 similarly works on detection light, the reduction of the detection efficiency of the detection light relative to the illuminating light, and the reduction of the resolution on the CCD 165 side can also be prevented.

In FIG. 14 exemplifies changing the magnification of the variable magnification optical system 173 by exchanging the variable magnification optical system inserted into the optical path depending on the exit pupil diameter of the objective, but the present invention is not limited to this application. That is, the variable magnification optical system 173 is configured as a variable zoom optical system, and at least one lens of the variable magnification optical system 173 is moved in the optical axis direction of the variable magnification optical system 173, thereby changing the magnification.

FIG. 14 exemplifies the scanning confocal microscope 170 including the variable magnification optical system 173 in addition to the pupil projection lens 154, but the present invention is not limited to this application. That is, instead of the pupil projection lens 154, an variable magnification optical system having the functions of the variable magnification optical system 173 and the pupil projection lens 154 can be included.

As described above, the scanning confocal microscope 170 can attain the same effect as the scanning confocal microscope 150. Furthermore, the magnification of the variable magnification optical system 173 is changed depending on the exit pupil diameter of the objective, thereby realizing the optimum illumination although the objectives are switched.

### Embodiment 4

FIG. 15 is the outline exemplifying the configuration of the scanning confocal microscope according to the present embodiment. A scanning confocal microscope 180 exemplified in FIG. 15 is a type of pattern projection apparatus, and includes the DMD 157 having a plurality of pixel devices each independently modulating light.

The scanning confocal microscope 180 is a variation example of the scanning confocal microscope 150 according to the embodiment 2. Therefore, the components common with the scanning confocal microscope 150 are assigned the same reference numerals, and the detailed descriptions are omitted here.

The scanning confocal microscope 180 is different from the scanning confocal microscope 150 in that it replaces the line illumination optical system 161 with a flat illumination optical system 181, and replaces the Galvano mirror 155 and the Galvano mirror 163 with mirrors 182 and 183.

Furthermore, the scanning confocal microscope 180 is also different from the scanning confocal microscope 150 in that by using the control device 157a the DMD 157 functions as a scanning unit for moving the position of the confocal aperture in the aperture pattern in the X- and Y-axis directions.

The scanning confocal microscope 180 is similar to the scanning confocal microscope 150 in the embodiment 2 in that the DMD 157 is sequentially controlled for each of the plurality of subaperture patterns obtained by dividing the aperture pattern for each scanning position.

The flat illumination optical system 181 is an optical system for conversion into illuminating light of uniform intensity and a flat section. The flat illumination optical system 181 can also be configured as an optical system including two Powell lenses, an optical system including two cylindrical lenses, or an optical system including one or two lens arrays. In this case, the section shape of the illuminating light is rectangular as with the outline of the DMD 157.

Furthermore, the flat illumination optical system 181 can convert the illuminating light emitted from the light source 162 into the illuminating light having a circular section. In this case, it is desired that the illuminating light has a circular section larger than the circumcircle of the outline of the DMD 157.

As described above, the scanning confocal microscope 180 can have the same effect as the scanning confocal microscope 150 according to the embodiment 2. Since the DMD 157 functions as a scanning unit for scanning the X- and Y-axis directions, other scanning units are not required, thereby simplifying the configuration of the scanning confocal microscope 180.

The DMD 157 is inclined by a predetermined angle with respect to the optical axis of the detection optical system. As a result, the focal surface of the detection optical system is also inclined with respect to the DMD 157. Therefore, according to the present embodiment, the configuration in which the DMD 157 is used as a scanning unit for scanning in the X- and Y-axis directions is effective when the focal depth of the detection optical system is large.

In addition, the configuration of combining the scanning confocal microscope 170 according to the embodiment 3 with the scanning confocal microscope 180 according to the present embodiment is also effective.

The variable magnification optical system 173 exemplified in FIG. 15 is arranged between the objective and the lens 156 (first lens) and the magnification is changed into a predetermined value depending on the exit pupil diameter of the objective. By changing the magnification of the variable magnification optical system 173 depending on the exit pupil diameter of the objective, the optimum illumination can also be realized although the objective is switched.

What is claimed is:

1. A pattern projection apparatus, comprising:
a spatial light modulator having a plurality of pixel devices each independently modulating light, and arranged at an optically conjugate position with respect to a sample; and
a control device dividing a modulation pattern of the spatial light modulator for irradiating the sample with illuminating light of a target form into a plurality of submodulation patterns of the spatial light modulator and controlling the spatial light modulator sequentially for each of the plurality of submodulation patterns.

2. The apparatus according to claim 1, wherein
the control device divides the modulation pattern into the plurality of submodulation patterns which are not simultaneously controlled in a first state in which the pixel devices adjacent in a direction of generating an optical path length difference lead the illuminating light to the sample.

3. The apparatus according to claim 1, wherein
the control device divides the modulation pattern into the plurality of submodulation patterns which are not simultaneously controlled in a first state in which the pixel devices adjacent on their respective sides in a direction of generating an optical path length difference lead the illuminating light to the sample.

4. The apparatus according to claim 1, further comprising
a projection optical system projecting the submodulation pattern to the sample, wherein
a numerical aperture on the spatial light modulator side of the projection optical system equals or exceeds a numerical aperture based on an Airy disc diameter corresponding to a size of the pixel device and a wavelength of the illuminating light.

5. The apparatus according to claim 4, wherein
the Airy disc diameter is equal to or smaller than a diameter of a circumcircle of the pixel devices.

6. The apparatus according to claim 5, wherein
the Airy disc diameter is equal to or smaller than a diameter of an inscribed circle of the pixel devices.

7. The apparatus according to claim 1, wherein
the pattern projection apparatus is a pattern stimulation microscope.

8. The apparatus according to claim 1, wherein
the pattern projection apparatus is a laser repair device.

9. The apparatus according to claim 1, wherein
the pattern projection apparatus is a medical laser radiation device.

10. A scanning confocal microscope, comprising:
a spatial light modulator having a plurality of pixel devices each independently modulating light, arranged at an optically conjugate position with respect to a sample, and functioning as a confocal stop; and
a control device dividing an aperture pattern of the confocal stop into a plurality of subaperture patterns and controlling the spatial light modulator sequentially for each of the plurality of subaperture patterns for each scanning position.

11. The microscope according to claim 10, wherein
the control device divides the aperture pattern into the plurality of subaperture patterns which are not simultaneously controlled in a first state in which the pixel devices adjacent on their respective sides in a direction of generating an optical path length difference lead the illuminating light to the sample.

12. The microscope according to claim 10, wherein
the control device divides the aperture pattern into the plurality of subaperture patterns not overlapping one another in a parallel movement in a direction of generating an optical path length difference.

13. The microscope according to claim 10, further comprising
an objective between the sample and the spatial light modulator, wherein
the control device changes the aperture pattern depending on an exit pupil diameter of the objective.

14. The microscope according to claim 10, further comprising:
a projection optical system projecting the subaperture pattern on the sample;
a photodetector detecting detection light generated from the sample; and
a detection optical system arranged between the spatial light modulator and the photodetector and leading the detection light which has passed the spatial light modulator to the photodetector, wherein:
a numerical aperture of the spatial light modulator side of the projection optical system equals or exceeds a numerical aperture determined by a first Airy disc diameter corresponding to a size of the pixel device and of a wavelength of the illuminating light; and
a numerical aperture of the spatial light modulator side of the detection optical system equals or exceeds a numerical aperture determined by a second Airy disc diameter corresponding to a size of the pixel device and of a wavelength of the detection light.

15. The microscope according to claim 14, wherein
the first and the second Airy disc diameters are equal to or smaller than a diameter of a circumcircle of the pixel devices.

16. The microscope according to claim 15, wherein
the first and the second Airy disc diameters are equal to or smaller than a diameter of an inscribed circle of the pixel devices.

17. The microscope according to claim 14, wherein
the projection optical system comprises:
an objective;
a first lens determining a numerical aperture on the spatial light modulator side of the projection optical system; and
a variable magnification optical system arranged between the objective and the first lens.

18. The microscope according to claim 17, wherein
a magnification of the variable magnification optical system is changed into a predetermined value depending on an exit pupil diameter of the objective.

19. The microscope according to claim. 10, further comprising
a scanning unit scanning the sample by a reciprocating motion, wherein
the control device controls the spatial light modulator to give different subaperture patterns between outgoing and incoming scanning paths on the sample by the scanning unit.

20. A pattern radiating method of irradiating a sample with illuminating light, comprising:
setting a pattern of the illuminating light for irradiating the sample;
dividing the pattern into a plurality of subpatterns subject to little interference; and
sequentially irradiating the sample with the plurality of subpatterns.
